(19) United States
(12) Patent Application Publication
(10) Pub. No.: US 2024/0052993 A1
(43) Pub. Date: Feb. 15, 2024

(54) ILLUMINATION MODULE WITH MULTI LIGHT SOURCES AND HEADLIGHT HAVING THE SAME

(71) Applicant: COPLUS INC., Tainan City (TW)

(72) Inventor: Jacob Wu, Tainan City (TW)

(21) Appl. No.: 17/945,733

(22) Filed: Sep. 15, 2022

Related U.S. Application Data
(60) Provisional application No. 63/397,711, filed on Aug. 12, 2022.

(51) Int. Cl. F21V 9/40; F21S 41/125; F21S 41/151; F21S 41/20; F21V 5/00

(52) U.S. Cl. CPC F21V 9/40; F21S 41/125; F21S 41/151; F21S 41/20; F21V 5/007; F21Y 2115/10

(57) ABSTRACT

The present invention is an illumination module with multi light sources includes at least one lens unit, at least one first light source and at least one second light source. The first light source is configured to generate a first color light, and project the first color light to the lens unit. The second light source is configured to generate a second color light, and project the second color light to the lens unit. The lens unit projects the first color light and the second color light to the front of the illumination module with multi light sources, such that the first color light and the second color light partially or fully overlap.

### REFERENCE TO RELATED APPLICATIONS

This non-provisional application claims priority under 35 U.S.C. § 119(a) on U.S. Provisional Application No. 63/397,711 filed Aug. 12, 2022, the entire contents of which are incorporated herein by reference.

### BACKGROUND

### Technical Field

This disclosure is related to vehicle parts, in particular to an illumination module with multi light sources and vehicle lamp having the illumination module.

### Related Art

Compared with incandescent lamps, LEDs have the advantages of small size, high brightness, long service life and power saving. LEDs have been used in automotive headlamps to produce high brightness white light, which can achieve good lighting effects under normal conditions. However, the color temperature of the white light generated by LED automotive headlamps is relatively high and often does not achieve the desired lighting effect in bad weather conditions, such as rainy weather, snowy weather or foggy weather. The white light may also affect the driver's vision, which in turn affects the safety of driving.

Therefore, in bad weather, drivers often need to turn on the fog lights and illuminate with the white light from the LED vehicle lamp set to increase the safety of driving. However, the fog lights are installed in a low position and irradiated at a close distance, which usually only have the effect of warning and do not provide good lighting effect. In addition, fog lights are mostly stand-alone, not even standard equipment when the car is sold. Additional retrofitting also increases installation costs.

### SUMMARY

In order to improve the shortcomings of the traditional LED headlamp in the art, this disclosure further proposes to set up a multiple color light sources in the vehicle lamp, which can generate different color lights at the same time and can significantly improve the problem of poor lighting effect of the LED headlamp in bad weather.

This disclosure proposes an illumination module with multiple light sources which includes at least one lens unit, at least one first light source and at least one second light source. The first light source is configured to generate a first color light, and project the first color light to the lens unit. The second light source is configured to generate a second color light, and project the second color light to the lens unit. The lens unit projects the first color light and the second color light to the front of the illumination module with multi light sources, such that the first color light and the second color light partially or fully overlap.

To achieve the object, this disclosure provides an illumination module with multi light sources, which comprises at least one lens unit; at least one first light source configured to generate a first color light, and project the first color light to the lens unit; and at least one second light source configured to generate a second color light, and project the second color light to the lens unit. The lens unit projects the first color light and the second color light to the front of the illumination module with multi light sources, such that the first color light and the second color light partially or fully overlap.

This disclosure further provides a vehicle lamp, which comprises the above-mentioned plurality of illumination modules integrated into a lamp housing.

In practical application, an ordinary headlamp can be directly replaced by the illumination module with multi light sources described in this disclosure, and the light control lever in the vehicle can be adjusted to enable the vehicle to emit a bad weather light source. In other words, the headlamp described in the present disclosure can be quickly and conveniently installed on an ordinary vehicle and improve the safety of the vehicle.

### BRIEF DESCRIPTION OF THE DRAWINGS

This disclosure will become more fully understood from the detailed description given herein below for illustration only, and thus not limitative of this disclosure, wherein:

FIG. 1 is a schematic structural diagram of a vehicle lamp having an illumination module with multi light sources according to an embodiment of this disclosure.

FIG. 2 is a cross view of the illumination module with multi light sources according to an embodiment of this disclosure.

FIG. 3 is a cross view of the illumination module with multi light sources according to another embodiment of this disclosure.

FIG. 4 is a schematic structural diagram of a light source array of the illumination module with multi light sources according to an embodiment of this disclosure.

FIG. 5 is a connection diagram of light sources, a control circuit and a switch of the illumination module with multi light sources according to an embodiment of this disclosure.

FIG. 6 is a connection diagram of light sources and the control circuit of the illumination module with multi light sources according to another embodiment of this disclosure.

FIG. 7 is a connection diagram of light sources and the control circuit of the illumination module with multi light sources according to another embodiment of this disclosure.

FIG. 8 is a cross view of the illumination module with multi light sources according to another embodiment of this disclosure.

FIG. 9 is a schematic structural diagram of a vehicle lamp having the illumination module with multi light sources according to another embodiment of this disclosure.

FIG. 10 is a schematic three-dimensional diagram of a lens unit of the illumination module with multi light sources according to an embodiment of this disclosure.

### DETAILED DESCRIPTION

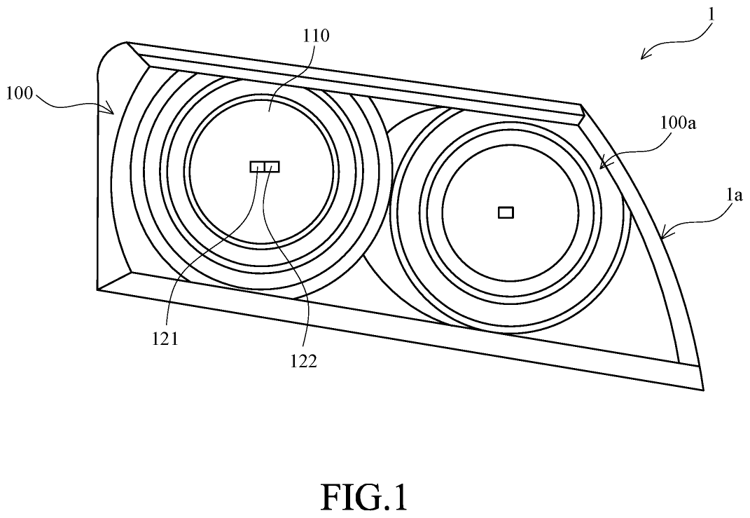

FIG. 1 is a schematic structural diagram of a vehicle lamp with an illumination module according to an embodiment of this disclosure. The vehicle lamp 1 comprises a plurality of illumination modules 100 with multi light sources, wherein illumination modules 100 are integrated into a lamp housing 1a. In one specific embodiment, the vehicle lamp 1 may be a headlight for vehicle. In practical application, an ordinary headlamp can be directly replaced by the vehicle lamp 1 described in this disclosure, so as to improve the lighting effect and safety of the vehicle.

In one specific embodiment, the vehicle lamp 1 may further includes an auxiliary illumination module 100a integrated in the lamp housing 1a. In one embodiment of this disclosure, the illumination module 100 may be a low beam module, and the auxiliary illumination module 100a may be a high beam module. In another embodiment of this disclosure, the illumination module 100 may be the high beam module, and the auxiliary illumination module 100a may be the low beam module.

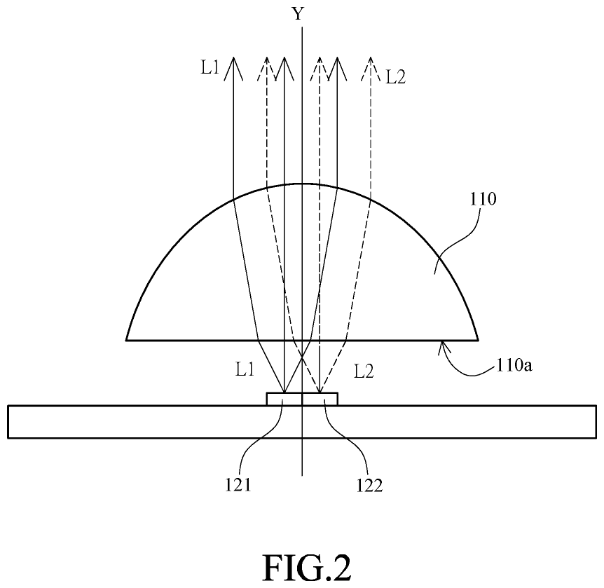

As shown in FIG. 1 and FIG. 2, the illumination module 100 with multi light sources includes at least one lens unit 110, at least one first light source 121, and at least one second light source 122.

As shown in FIG. 1 and FIG. 2, the first light source 121 and the second light source 122 are respectively configured to generate a first color light L1 and a second color light L2. The first color light L1 and the second color light L2 are light with different wavelengths, colors, or color temperatures. For example, the first color light L1 is white light, and the second color light L2 is yellow light. In one specific embodiment, the first light source 121 and the second light source 122 may be light emitting diodes (LEDs). The first light source 121 and the second light source 122 are light emitting diodes are only one embodiment of this disclosure, but other type of light sources is not excluded in this disclosure.

As shown in FIG. 1 and FIG. 2, the first light source 121 is configured to project the first color light L1 to the lens unit 110, and the second light source 122 is configured to project the second color light L2 to the lens unit 110, wherein incident positions of the first color light L1 and the second color light L2 on the lens unit 110 are different. The lens unit 110 refracts and projects the first color light L1 and the second color light L2 to the front of the illumination module 100 with multi light sources, such that the first color light L1 and the second color light L2 partially or fully overlap.

As shown in FIG. 1 and FIG. 2, the lens unit 110 is a single lens including a light incident surface 110a, and the first color light L1 and the second color light L2 enter the lens unit 110 through the light incident surface 110a. The incident positions of the first color light L1 and the second color light L2 on the light incident surface 110a are different, such that the refracted lights project to different angle ranges.

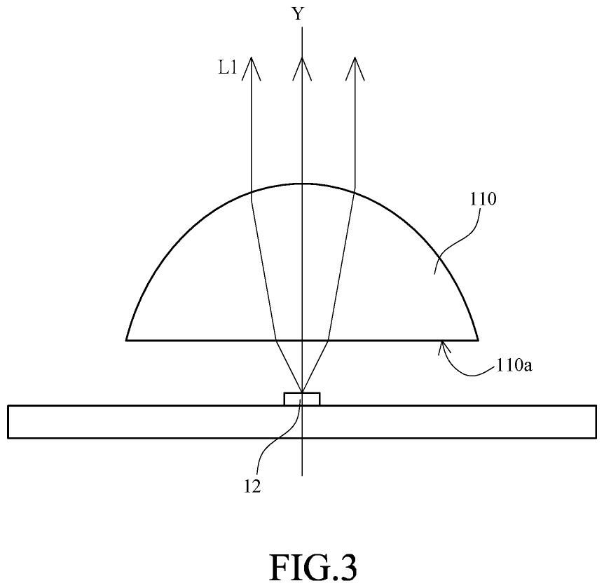

As shown in FIG. 3, the lens unit 110 is a single lens, and the first light source 121 and the second light source 122 may be integrated into a single variable color light module 12. For example, the variable color light module 12 may include two LED dies, and the two LED dies are packaged to form a LED device and can be used to generate color light of diverse colors. The variable color light module 12 is configured to generate the first color light L1 and the second color light L2. For example, the first color light L1 and the second color light L2 enter the lens unit 110 from the same or similar incident position of the light incident surface 110a, and are projected to the front of the lens unit 110 through a similar optical path, such that the refracted first color light L1 and the refracted second color light L2 project to approximately overlapping angular ranges.

The lens unit 110 described in this disclosure may be a single lens or a lens assembly composed of multiple lenses, and each lens may be a spherical lens or an aspherical lens.

In one embodiment, the lens unit 110 is a lens having a light incident surface 110a, and the incident positions of the first color light L1 and the second color light L2 on the light incident surface 110a are different. The first light source 121 is adjacent to the second light source 122, and both close to an optical axis Y or a focal point of the lens. The first light source 121 and the second light source 122 respectively project the first color light L1 and the second color light L2 to the lens on different incident positions, and through this single lens refracts the first color light L1 and the second color light L2 to the front of the illumination module 100 with multi light sources, such that the first color light L1 and the second color light L2 partially overlap to form a lighting for bad weather.

In one embodiment of this disclosure, the projection height/angle of the second color light L2 is set to be lower than the projection height/angle of the first color light L1, so as to avoid the second color light L2 (in particular when it is yellow light) from impacting the oncoming vehicle, but can produce sufficient lighting on the ground near.

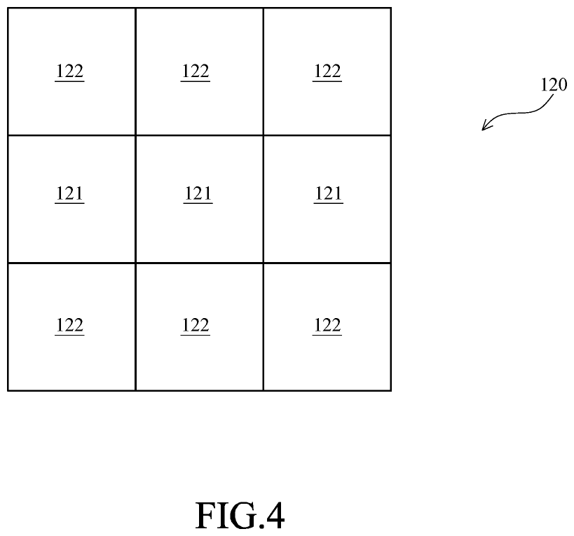

The first light source 121 and the second light source 122 of the illumination module 100 with multi light sources as shown in FIG. 1, FIG. 2 and FIG. 4 are adjacent to each other. For example, plural first light sources 121 and plural second light sources 122 are closely arranged into a light source array 120.

As shown in FIG. 4, the light source array 120 may include nine LEDs, such as three first light sources 121 and six second light sources 122, wherein two sides of each of the three first light sources 121 are provided one second light source 122.

The light source array 120 in FIG. 4 is only an example. In practical, the number and position of the first light sources 121 and the second light sources 122 of the light source array 120 may be adjusted according to the beam pattern and illumination requirements, so that the illumination module 100 with multiple light sources produces the first color light L1 and the second color light L2 for bad weather to comply with the relevant laws and regulations.

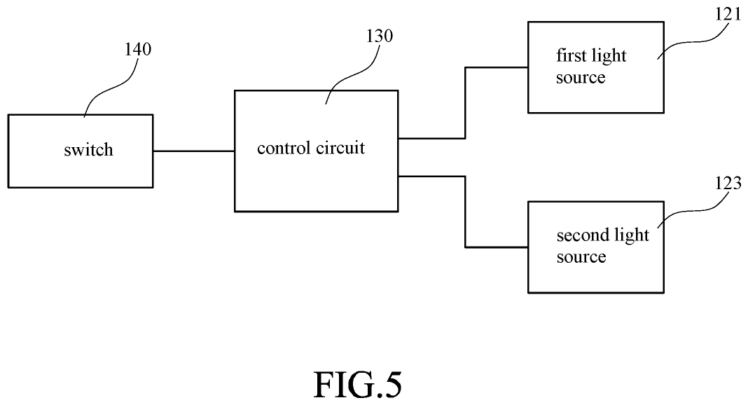

As shown in FIG. 5, the illumination module 100 with multi light sources further includes a control circuit 130 and a switch 140. The control circuit 130 is configured to control turn-on/turn-off of the first light source 121 and the second light source 122. For example, the control circuit 130 may be a multistage toggle switch. The switch 140 may be a high beam switch or an overtaking light switch of the vehicle. The switch 140 is configured to transmit a trigger signal to the control circuit 130, and the control circuit 130 turns on or turns off the first light source 121 and the second light source 122 according to the trigger signal.

When the first light source 121 is turned on, the control circuit 130 turns on or off the second light source 122 by accepting the trigger signal for a specific number of times as a cycle of triggering. For example, the switch 140 turns on the second light source 122 every three times it is triggered, and then turns off the second light source 122 when it is triggered again, until switch 140 is triggered another three times and turns on the second light source 122 again.

Specifically, the illumination module 100 with multi light sources of this disclosure may have three operation modes. The first operation mode is the first light source 121 and the second light source 122 are not emitting light, which is usually applied in the daytime or a well-lit driving environment.

The second operation mode is that the first light source 121 and the second light source 122 of the illumination module 100 emit light simultaneously. The first light source 121 is turned on at first to emit the first color light L1, while the second light source 122 is turned off and emits no light. The control circuit 130 receives the trigger signal for the specific number of times when the first light source 121 is turned on, and turns on the second light source 122 to emit the second color light L2 according to the cycle of triggering, and the first light source 121 remains to emit the first color light L1, so that the illumination module 100 with light sources emits the first color light L1 and the second color light L2 simultaneously. The second operation mode is usually used in the night or under-illuminated vehicle environment.

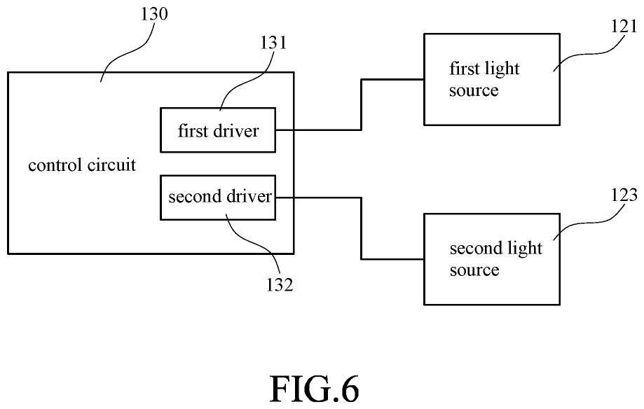

As shown in FIG. 6, in this case, the first light source 121 and the second light source 122 may need be turned on simultaneously, such as in the second operation mode. Therefore, the control circuit 130 may further include a first driver 131 and a second driver 132. The first driver 131 is configured to provide power to the first light source 121, and the second driver 132 is configured to provide power to the second light source 122. The two drivers provide sufficient total electrical power to the first light source 121 and the second light source 122, so as to avoid insufficient luminosity of the first color.

The first driver 131 and the second driver 132 integrated into the control circuit 130 shown in FIG. 6 is only one embodiment of this disclosure and is not intended to limit the scope of the patent application of the present invention. In other embodiments, the first driver 131 and the second driver 132 may be located outside the control circuit 130 and be connected to the control circuit 130. For example, the first driver 131 is located between the control circuit 130 and the first light source 121, and the second driver 132 is located between the control circuit 130 and the second light source 122.

The third operation mode is that only one of the first light source 121 and the second light source 122 of the illumination module 100 with multiple light sources is turned on. In this case, if the first light source 121 is turned off, the control circuit 130 receives the trigger signal for the specific number of times, and turns on the second light source 122 to emit the second color light L2 according to the cycle of triggering and turns off the first light source 122. If the first light source 121 is turned on and the low beam group is turned on, the control circuit 130 receives the trigger signal for the specific number of times, turns on the second light source 122 according to the cycle of triggering, and turns off the first light source 121.

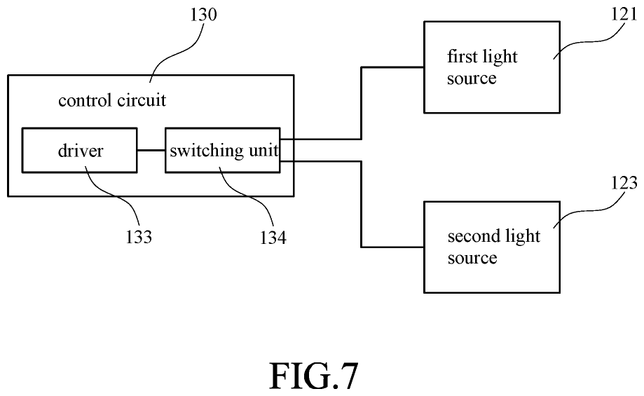

As shown in FIG. 7, in this case, the first light source 121 and the second light source 122 will not be turned on at the same time. Thus, the control circuit 130 only includes a driver 133 and a switching unit 134, wherein the driver 133 is configured to provide power to the switching unit 134, and then the switching unit 134 provides power to the first light source 121 or the second light source 122 depending on demand.

The driver 133 integrated into the control circuit 130 shown in FIG. 7 is only one embodiment of this disclosure and is not intended to limit the scope of the patent application of the present invention. In other embodiments, the driver 133 may be located outside the control circuit, and be connected to the control circuit 130.

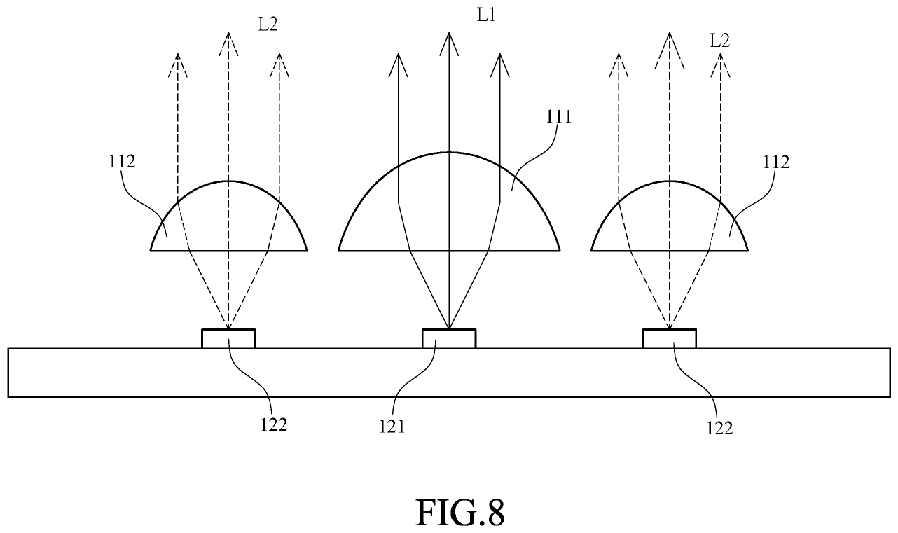

As shown in FIG. 8, a distance exists between the first light source 121 and the second light source 122. The lens unit 110 includes a first lens unit 111 and a second lens unit 112. The first lens unit 111 and the second lens unit 112 have different focal lengths, resulting in different divergence angles.

The first light source 121 faces the first lens unit 111, and projects the first color light L1 to the first lens unit 111 that is configured to refract the first color light L1 generated by the first light source 121. The second light source 122 faces the second lens unit 112, and projects the second color light L2 to the second lens unit 112 that is configured to refract the second color light L2 generated by the second light source 122.

In the embodiment of FIG. 8, the first lens unit 111 and the second lens unit 112 are provided separately, and are respectively arranged corresponding to the first light source 121 and the second light source 122. In addition, along the paper direction of FIG. 8, the first lens unit 111 or the second lens unit 112 may include two or more lenses arranged in parallel.

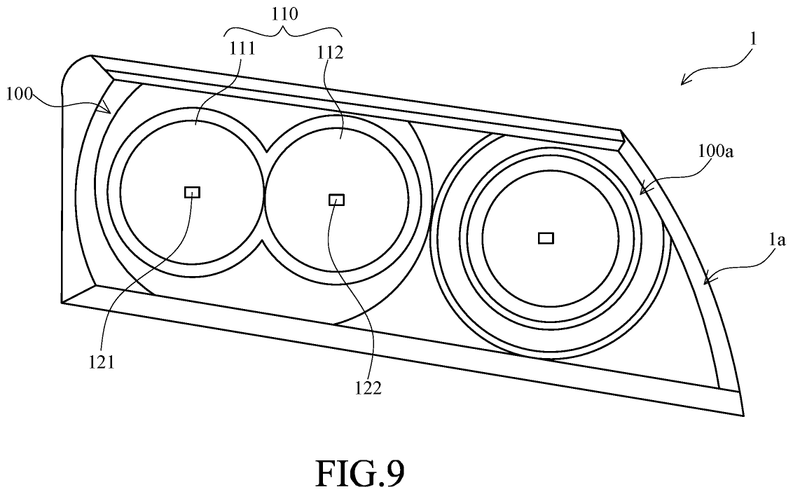

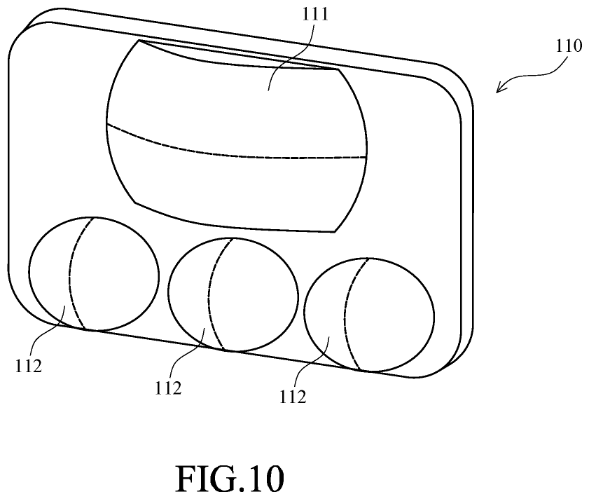

In the embodiment of FIG. 9 and FIG. 10, the first lens unit 111 and the second lens unit 112 are integrated into an integrally formed component. As shown in FIG. 9, the edge of the first lens unit 111 is directly connected to the second lens unit 112. As shown in FIG. 10, the first lens unit 111 and the second lens unit 112 are disposed on a transparent substrate 114, and respectively cover or face the first light source 121 and the second light source 122.

In practical application, the ordinary headlamp can be directly replaced by the illumination module 100 described in this disclosure, and the light control lever in the vehicle can be adjusted, so that the vehicle is able to emit a lighting for bad weather. In other words, the vehicle lamp described in thus disclosure can be quickly and conveniently installed on the general vehicle, so as to improve the safety of the vehicle.

The above description is only a preferred embodiment of this disclosure and is not intended to limit the scope of this disclosure. Modifications should be included within the scope of the patent application of this disclosure.

1. An illumination module with multi light sources, comprising:
at least one lens unit;
at least one first light source configured to generate a first color light, and project the first color light to the lens unit;
at least one second light source configured to generate a second color light, and project the second color light to the lens unit, wherein the lens unit projects the first color light and the second color light to a front of the illumination module with multi light sources, such that the first color light and the second color light partially or fully overlap; and
a control circuit being configured to turn-on or turn-off the second light source, and a switch being configured to transmit trigger signals to the control circuit,
wherein the control circuit receives the trigger signal for a specific number of times as a cycle, and turns on or off the second light source after the cycle.

2. The illumination module with multi light sources as claimed in claim 1, wherein the lens unit is a single lens with a light incident surface, the first light source is adjacent to the second light source, and close to an optical axis of the lens, wherein incident positions of the first color light and the second color light on the light incident surface are different.

3. The illumination module with multi light sources as claimed in claim 1, wherein the first light source and the second light source are integrated into a single variable color light module, and projection ranges of the first color light and the second color light overlap.

4. The illumination module with multi light sources as claimed in claim 1, wherein the illumination module includes plural first light sources and plural second light sources arranged into a light source array.

5. The illumination module with multi light sources as claimed in claim 1, wherein a distance exists between the first light source and the second light source, and the lens unit includes a first lens unit and a second lens unit, the first lens unit is configured to refract the first color light generated by the first light source, and the second lens unit is configured to refract the second color light generated by the second light source.

6. The illumination module with multi light sources as claimed in claim 5, wherein the first lens unit and the second lens unit have different focal lengths.

7. The illumination module with multi light sources as claimed in claim 6, wherein the first lens unit and the second lens unit are provided separately.

8. The illumination module with multi light sources as claimed in claim 6, wherein the first lens unit and the second lens unit are integrally formed.

9. The illumination module with multi light sources as claimed in claim 1, wherein the first color light is a white light, and the second color light is a yellow light.

10. (canceled)

11. The illumination module with multi light sources as claimed in claim 1, wherein the control circuit receives the trigger signal for the specific number of times when the first light source is turned on, and turns on the second light source to emit the second color light according to the cycle of triggering, and the first light source remains to emit the first color light.

12. The illumination module with multi light sources as claimed in claim 1, wherein the control circuit further includes a first driver and a second driver, the first driver is configured to provide power to the first light source, and the second driver is configured to provide power to the second light source.

13. The illumination module with multi light sources as claimed in claim 1, wherein the control circuit receives the trigger signal for the specific number of times when the first light source is turned off, and turns on the second light source to emit the second color light according to the cycle of triggering; or the control circuit receives the trigger signal for the specific number of times when the first light source is turned on, and turns on the second light source to emit the second color light according to the cycle of triggering and turns off the first light source.

14. The illumination module with multi light sources as claimed in claim 13, wherein the control circuit includes a driver and a switching unit, the driver is configured to provide power to the switching unit, and then provide power to the first light source or the second light source via the switching unit.

15. The illumination module with multi light sources as claimed in claim 1, wherein the first light source and the second light source are LEDs.

16. A vehicle lamp, comprising:
a plurality of illumination modules as claimed in claim 1, integrated into a lamp housing.

17. The vehicle lamp as claimed in claim 16, further including at least one auxiliary illumination module integrated into the lamp housing.
